(19) United States
(12) Patent Application Publication
(10) Pub. No.: US 2004/0145077 A1
(43) Pub. Date: Jul. 29, 2004

(54) Highly diverse mixtures, method for the production, and use thereof

(76) Inventors: Dietrich Fleischer, Darmstadt (DE); Thomas Reisinger, Ingelheim (DE); Arnold Schneller, Messel (DE); Reinhard Wagener, Hofheim (DE); Matthias Rehahn, Karlsruhe (DE); Martin Bastian, Veitschochheim (DE); Harald Pasch, Bensheim (DE); Ingo Alig, Weiterstadt (DE)

Correspondence Address: CONNOLLY BOVE LODGE & HUTZ, LLP, P O BOX 2207, WILMINGTON, DE, 19899, US

(21) Appl. No.: 10/478,760

(22) PCT Filed: May 22, 2002
(86) PCT No.: PCT/EP02/05592

(30) Foreign Application Priority Data
May 25, 2001 (DE) 101 25 571.3

(51) Int. Cl. B29C 47/00; B29C 47/38

(52) U.S. Cl. 264/211; 264/349; 264/211.21

(57) ABSTRACT

The present invention relates to a process for preparing mixture from a large number of components, the concentrations of the components used being capable of continuous variation over prescribed ranges in a very simple manner. For this, the mixtures are continuously prepared in a mixing assembly and continuously converted into a form which can be subjected to further processing. By way of example, the invention may be used for producing substance libraries for high-throughput screening in the plastics industry, in particular of mixtures of polymers with one another and of mixtures of polymers with added materials.

The use of highly automated, combinatorial methods to test the activity of substances is a well-established constituent of research in the pharmaceuticals and crop protection sectors. The term combinatorial techniques here generally refers to the preparation of a large number of chemically different compounds or mixtures and the subsequent rapid testing of one or more properties of these substance libraries. The synonymous term high-throughput screening is also used, because a particular advantage, inter alia, which can be achieved by these methods is significantly faster sample throughput.

For example, use of these methods permits the activity of some tens of thousands of substances to be checked every day in searches for active ingredients. Examples of the use of combinatorial methods are given by

Lowe, JCS Reviews, 309-317 (1995),

N. K. Terrett, Combinatorial Chemistry, Oxford University Press, Oxford, 1998,

Combinatorial Chemistry and Molecular Diversity in Drug Discovery (ed.: E. M. Gordon, J. F. Kerwin), Wiley, New York 1998.

Recently, these methods of combinatorial chemistry and high-throughput screening have received increasing attention in materials science, for example in the development of materials with optical uses, or the discovery of new catalysts. An example of an overview of these relatively new developments is found in the article by B. Jandeleit, D. J. Schäfer, T. S. Powers, H. W. Turner, W. H. Weinberg in Angewandte Chemie 1999, 111, 2648-2689.

Based on the knowledge and experience available to date, the use of combinatorial methods is always advisable when the intention is to analyze and/or synthesize complex systems for which one or more of the following properties are applicable:

1.) Little or no knowledge is available concerning structure-property relationships or mechanisms of action.

2.) Very complicated and time-consuming experiments have mostly been required hitherto in order to obtain results in relation to the preparation and testing of these systems.

3.) The systems are composed of a relatively large number of substance components and process parameters with differing function which is not known in detail, and interactions between the components and parameters.

Combinatorial methods have hitherto been very little used in research and development in the formulations sector, particularly in polymer compositions.

The approaches described hitherto for the production and testing of substance libraries, including those for polymers or polymer compositions, are based on discrete, spatially separate containers (compartments) in which the mixtures are produced and then tested.

U.S. Pat. No. 5,985,356 describes the copolymerization of styrene with acrylonitrile in toluene in an arrangement composed of 16 compartments of size 3×3×5 mm. This requires complicated apparatuses for precise metering of monomers and initiator.

WO 99/52962 describes a method for preparing alternating copolymers by systematically varying the diol component and, respectively, the dicarboxylic acid component in an arrangement of 8×14 reaction vessels.

WO 00/40331 describes an apparatus for the polymerization of monomers in reactors arranged in parallel.

A discussion paper from the National Institute of Standards and Technology (M. R. Nyden, J. W. Gilman, Proceedings, Fire Retardant Chemicals Association, Mar. 12-15, 2000. Washington, D.C., 1-5 pp. 2000) mentions the continuous production of polymer compositions. (Internet address: http://fire.nist.gov/bfrlpubs/fire00/PDF/f00017.pdf).

That publication discusses a process for the continuous production and testing of polymer compositions with flame retardants, proposing for that purpose a system composed of a computer-controlled gravimetric solids feed and an extruder which is not specified in any further detail. The arrangement is intended to extrude polymers with flame-retardant additives in concentrations programmed in advance, these then being analyzed on-line and tested for fire performance.

The variation in concentration of the flame-retardant additive is intended to take place deterministically by way of the computer-controlled gravimetric feed unit in the previously-set concentration steps. It is known that the change of a process parameter, for example of a metering quantity or metering rate, initially leads to non-steady-state behavior of the mixer before a constant and well-defined product constitution is again obtained at the mixer outlet. The duration of the non-steady-state phase in which none of the product with previously programmed constitution is obtained may be as long as the residence time, or even longer. The generally broad distribution of residence time in a melt extruder therefore represents a marked limitation of this approach to high-throughput screening. That publication does not disclose or propose any connection between the continuous production of polymer compositions and combinatorial methods and high-throughput screening.

Polymers capable of melt-processing are usually mixed continuously by way of a melt extrusion step with additional components and further processed either directly or batchwise to give moldings.

The application of this continuous production of polymer compositions to combinatorial methods and high-throughput screening has not previously been indicated.

It is an object of the present invention to use simple measures to eliminate the disadvantages of the prior art. A further object of the present invention consists in providing, for the first time, a process for the high-throughput screening of polymer compositions. This object is achieved through a process for the continuous preparation of mixtures from at least one thermoplastic polymer and at least one additive, which comprises continuously feeding at least one thermoplastic polymer to a mixing assembly and melting the same and mixing the same with one or more additives, the concentration of at least one additive being varied continuously, and continuously discharging the polymer mixture from the mixing assembly and converting the same into a form which can be subjected to further processing and testing.

The process of the invention also permits simultaneous metering of two or more additives in varying concentration into the screening experiment, and a substance library can be generated via simultaneous variation of the concentration of the additives. The mixtures prepared by the process of the invention may encompass part of the volume of the phase diagram of a multicomponent mixture, and this volume may have a relatively large number of dimensions; it is therefore suitable for extensive high-throughput screening; concentration ranges below 1% can be encompassed here.

Surprisingly, it has also been found that, by utilizing the mixing assembly's residence time characteristics, which per se are disadvantageous, in the process of the invention it is possible to prepare, very rapidly and simply, and continuously, mixtures composed of one or more thermoplastic polymers and of one or more additives with a very high degree of diversity in the concentrations of the components used. The mixtures prepared continuously in the mixing assembly are continuously converted into a form which can be subjected to further processing and testing.

One advantageous embodiment of the invention is a process for the continuous preparation of mixtures from at least one thermoplastic polymer and at least one additive, which comprises continuously feeding at least one thermoplastic polymer to a mixing assembly and melting the same and mixing the same with one or more additives, one or more additives being fed to the mixing assembly in such a way that the residence time characteristics of the mixing assembly generate an initially rising (hereinafter also termed “heading”) and then falling (hereinafter also termed “tailing”) concentration gradient of one or more additives in the discharged polymer mixture, and continuously discharging the polymer mixture from the mixing assembly and converting the same into a form which can be subjected to further processing and testing.

The metering profiles of one or more additives may, by way of example, assume the form of a concentration pulse and/or of a concentration pulse sequence and/or of a concentration ramp.

Through use of the process of the invention and its diverse embodiments it is possible to omit any pre-programmed control and setting of defined points in the phase diagram of a multicomponent mixture while generating a substance library which nevertheless encompasses a predetermined partial volume of the multidimensional phase diagram. During the process of the invention there are no non-productive waiting times due to the time required for conversion between steady-state operating conditions of the experimental arrangement. This process therefore provides, for the first time, the basis for cost-effective high-throughput screening. In particular, very small concentrations of one or more components can be set and studied by utilizing the tailing characteristics of the mixing assembly after the addition of an additive, for example by way of a concentration pulse. In contrast to the batchwise preparation of substance libraries in compartments, the process of the invention permits the preparation of mixtures having process parameters with close approximation to those from industrial production processes.

Another advantage of mixtures prepared by the present process is that the product prepared continuously can easily be divided into discrete fragments of any desired size, whereas the processes of the prior art can, by virtue of the process, only give discrete fragments, the properties of which have to be individually planned prior to execution of the experiment, and which cannot be converted into a continuous stream of product, even if that would be advantageous for certain methods of investigation.

The person skilled in the art knows that it is possible to influence the effects described, such as tailing or heading or mixing, via the variation of one or more process parameters of the mixing assembly, these in turn being capable of considerably altering the properties of the material or product as a result of the change in mechanical and thermal stress history. This circumstance may be utilized advantageously in order to enhance or attenuate the effects described. Examples of relevant process parameters here are rotation rate of the mixing assembly, barrel geometry and screw geometry, location(s) of feed, location(s) of devolatilization, barrel temperature, etc., and these may be varied continuously or in individual stages or in a sequence of small stages, in order to produce extrudates which can be used for process optimization.

In one preferred embodiment of the process of the invention, the mixing assembly is composed of at least one screw-based machine. In one preferred embodiment, extruders are used as screw-based machines, particular preference being given to the use of twin-screw extruders.

in one preferred embodiment, suitable die design is used to achieve not only the gradient in the direction of conveying (hereinafter “longitudinal gradient”) but also a gradient running perpendicular to the direction of conveying (hereinafter “transverse gradient”), the result being longitudinal and transverse variation of the mixtures obtained. It is known that the selection of die geometry in relation to the pressure drop along the flow lines has a decisive effect on the elimination of the transverse gradient. According to the invention, this transverse gradient can be used specifically in order to increase by many times the diversity of the mixtures. This transverse gradient can be generated via specific selection of the die geometry.

The invention further provides the use of the highly diverse mixtures prepared by the process of the invention as a substance library for high-throughput screening and combinatorial methods.

The invention also provides moldings which have been produced from mixtures by the process of the invention. In one preferred embodiment, these are strips of film, extrudates, and pellets produced from these extrudates.

In order that the precise residence time characteristics of the additives are known, calibration of the mixing assembly is advantageous, in particular for the preparation of multicomponent mixtures, i.e. of mixtures with polymer and two or more additives, these being intended to be present in the finished mixture in mutually independent concentration gradients. In this way, the addition of the various additives may, where appropriate, be undertaken separately from one another, either spatially and/or chronologically, in order that the mixtures of the invention have the desired concentration gradients.

The mixtures of the invention are prepared continuously and have at least one concentration gradient of the additives used. For the purposes of the present invention, continuously means that the process proceeds continuously and the end product is discharged in a continuous product stream from the mixing assembly, in particular not having the form of discrete fragments. By way of example, the preferred form of the mixture is that of an extrudate or of a self-supporting strip of film, the result being that these can, by way of example, readily be converted by chopping or stamping of the strip of film or pelletization of the extrudate into discrete fragments, if this is advantageous for subsequent processing or investigation. The mixtures prepared by the process of the invention feature a concentration gradient of at least one additive longitudinally with respect to the extrudate produced by the continuous mixing assembly.

This means that the concentration of the additive in the mixture changes. The concentration profile along the extrudate depends on the residence time characteristics of the mixing assembly and on the spatial separation between the feed point for the respective additive and the extrusion die. In one advantageous embodiment of the present invention, at least one additive is added, advantageously in the form of a concentration pulse and/or of a concentration pulse sequence and/or of a concentration ramp with the result that the concentration of at least one additive in the resultant mixture changes as a function of time and of the amount of mixture discharged after this concentration pulse. It is advantageous to achieve a relatively steep heading characteristic and a flat tailing characteristic for a feed pulse.

The mixtures prepared according to the invention are advantageously polymer compositions. Polymer compositions are understood to be mixtures of a polymer with one or more other polymers and/or with organic and/or inorganic additives. The additives may be liquid or solid, and their processing properties may vary widely. Examples of processing properties are viscosity, density or, in the case of liquids, surface tension, or, in the case of solid additives, grain size, grain shape, grain size distribution, hardness, flowability, adhesion, or bulk density. The additives give the polymer composition the properties demanded by the respective application. Examples which may be mentioned of the large number of additives known in the prior art are fillers, which may be used in the form of beads, fibers, or lamellae, with dimensions of from 10 nm to a few millimeters. They are used mainly to adjust the mechanical properties of the polymer compositions.

Examples of other additives are light stabilizers, in particular stabilizers to prevent damage by UV and visible light, flame retardants, processing aids, pigments, lubricants and friction additives, coupling agents, impact modifiers, flow agents, mold-release agents, nucleating agents, acid scavengers, base scavengers, antioxidants. These additives for plastics are described by way of example by H. Zweifel in: Plastics Additives Handbook, 5th edition, Hanser Verlag 2000, incorporated herein by way of reference. Other additives which may be used are thermoplastic and/or non-thermoplastic polymers, in particular thermoplastic polymers, thus preparing blends and polymer alloys with concentration gradients.

For the purposes of the invention, the term polymers fundamentally includes all of the known, synthetic, naturally occurring, and modified naturally occurring polymers, i.e. thermoplastic polymers which can be processed by melt extrusion. By way of example, mention may be made of:

polylactones, such as poly(pivalolactone), poly(caprolactone) and the like;

polyurethanes, such as the polymerization products of the diisocyanates, e.g. of naphthalene 1,5-diisocyanate; p-phenylene diisocyanate; m-phenylene diisocyanate, tolylene 2,4-diisocyanate, tolylene 2,6-diisocyanate, diphenylmethane 4,4′-diisocyanate, 3,3′-dimethylbiphenyl 4,4′-diisocyanate, diphenylisopropylidene 4,4′-diisocyanate, 3,3′-dimethyldiphenyl 4,4′-diisocyanate, 3,3′-dimethyldiphenylmethane 4,4′-diisocyanate, 3,3′-dimethoxybiphenyl 4,4′-diisocyanate, dianisidine diisocyanate, toluidine diisocyanate, hexamethylene diisocyanate, 4,4′-diisocyanatodiphenylmethane, hexamethylene 1,6-diisocyanate, or dicyclohexylmethane 4,4′-diisocyanate and the like, with long-chain diols, for example with poly(tetramethylene adipate), poly(ethylene adipate), poly(butylene 1,4-adipate), poly(ethylene succinate), poly(butylene 2,3-succinate), with polyether diols, and/or with one or more diols such as ethylene glycol, propylene glycol, and/or with a polydiol, such as diethylene glycol, triethylene glycol, and/or tetraethylene glycol and the like;

polycarbonates, such as poly[methanebis(phenyl 4-carbonate)], poly[1,1-etherbis(phenyl 4-carbonate)], poly[diphenylmethanebis(phenyl 4-carbonate)], poly[1,1-cyclohexanebis(phenyl carbonate)] and the like;

polysulfones, such as the reaction product of the sodium salt of 2,2-bis(4-hydroxyphenyl)propane or of 4,4′-dihydroxydiphenyl ether with 4,4′-dichlorodiphenyl sulfone and the like;

polyethers, polyketones, and polyether ketones, such as polymerization products of hydroquinone, of 4,4′-dihydroxybiphenyl, of 4,4′-dihydroxybenzophenone, or of 4,4′-dihydroxydiphenylsulfone with dihalogenated, in particular difluorinated or dichlorinated, aromatic compounds of the type represented by 4,4′-dihalodiphenyl sulfone, 4,4′-dihalodibenzophenone, bis(4,4′-dihalobenzoyl)benzene, 4,4′-dihalobiphenyl and the like;

polyamides, such as poly(4-aminobutanoic acid), poly(hexamethyleneadipamide), poly(6-aminohexanoic acid), poly(m-xylyleneadipamide), poly(p-xylylenesebacamide), poly(2,2,2-trimethylhexamethyleneterephthalamide), poly(metaphenyleneisophthalamide) (NOMEX), poly(p-phenyleneterephthalamide) (KEVLAR) and the like;

polyesters, such as poly(ethylene acetate), poly(ethylene 1,5-naphthalate), poly(cyclohexane-1,4-dimethylene terephthalate), poly(ethylene oxybenzoate) (A-TELL), poly(parahydroxybenzoate) (EKONOL), poly(cyclohexylidene-1,4-dimethylene terephthalate) (KODEL), (cis)poly(cyclohexylidene-1,4-dimethylene terephthalate) (Kodel), polyethylene terephthalate, polybutylene terephthalate and the like;

poly(arylene oxides), such as poly(2,6-dimethylphenylene 1,4-oxide), poly(2,6-diphenylphenylene 1,4-oxide) and the like;

liquid-crystalline polymers, such as the polycondensation products from the group of monomers consisting of terephthalic acid, isophthalic acid, naphthalene-1,4-dicarboxylic acid, naphthalene-2,6-dicarboxylic acid, biphenyl-4,4′-dicarboxylic acid, 4-hydroxybenzoic acid, 6-hydroxy-2-naphthalenedicarboxylic acid, hydroquinone, 4,4′-dihydroxybiphenyl, 4-aminophenol and the like;

poly(arylene sulfides), such as poly(phenylene sulfide), poly(phenylene sulfide ketone), poly(phenylene sulfide sulfone) and the like;

polyetherimides;

vinyl polymers and their copolymers, such as polyvinyl acetate, polyvinyl chloride, polyvinyl butyral, polyvinylidene chloride, ethylene-vinyl acetate copolymers and the like;

polyacrylic derivatives, polyacrylate and its copolymers, such as polyethyl acrylate, poly(n-butyl acrylate), polymethyl methacrylate, polyethyl methacrylate, poly(n-butyl methacrylate), poly(n-propyl methacrylate), polyacrylonitrile, water-insoluble ethylene-acrylic acid copolymers, water-insoluble ethylene-vinyl alcohol copolymers, acrylonitrile copolymers, methyl methacrylate-styrene copolymers, ethylene-ethyl acrylate copolymers, acrylonitrile-butadiene-styrene copolymers and the like;

polyolefins, such as low-density poly(ethylene), polypropylene, chlorinated low-density poly(ethylene), poly(4-methyl-1-pentene), poly(ethylene), poly(styrene) and the like;

water-insoluble ionomers; poly(epichlorohydrin);

furan polymers, such as poly(furan);

cellulose esters, such as cellulose acetate, cellulose acetate butyrate, cellulose propionate and the like;

silicones, such as poly(dimethylsiloxane), poly(dimethylsiloxane-cophenylmethylsiloxane) and the like;

protein thermoplastics;

and also all of the mixtures and alloys (miscible and immiscible blends) of two or more of the polymers mentioned.

For the purposes of the invention, thermoplastic polymers also encompass thermoplastic elastomers derived, for example, from one or more of the following polymers:

brominated butyl rubber, chlorinated butyl rubber, polyurethane elastomers, fluoroelastomers, polyester elastomers, polyvinyl chloride, butadiene-acrylonitrile elastomers, silicone elastomers, poly(butadiene), poly(isobutylene), ethylene-propylene copolymers, ethylene-propylenediene terpolymers, sulfonated ethylene-propylene-diene terpolymers, poly(chloroprene), poly(2,3-dimethylbutadiene), poly(butadiene-pentadiene), chlorosulfonated poly(ethylenes), poly(sulfide) elastomers, block copolymers, built up from segments of amorphous or of (semi)crystalline blocks, such as poly(styrene), poly(vinyltoluene), poly(tert-butylstyrene), polyesters, and the like, and of elastomeric blocks, such as poly(butadiene), poly(isoprene), ethylene-propylene copolymers, ethylene-butylene copolymers, ethylene-isoprene copolymers, and hydrogenated derivatives of these, e.g. SEBS, SEPS, SEEPS, and also hydrogenated ethylene-isoprene copolymers with a relatively high proportion of 1,2-linked isoprene, polyethers and the like, such as the products marketed by Kraton Polymers with the trade name KRATON®.

The purpose of the metering process is to feed powder or liquid or pellets to the mixing assembly, either in pure form or premixed in masterbatches. This feed of the polymer(s) and, where appropriate, of other additives takes place continuously.

For the process of the invention, use may be made of the metering methods of the prior art for the feed of the individual components to the mixing assembly. A comprehensive description of metering systems used in industry was published in 1989 in “Dosieren von Feststoffen (Schüttgütern)” [Metering of (bulk) solids] by the company Gericke. Supplementary to that publication, the VDI report “Kunststoffe im Automobilbau” [Plastics in automotive construction], Vol. No.: 4224 (2000) includes an up-to-date section concerning the metering systems usually used. These publications are incorporated by way of reference.

Within the metering process, a distinction is made between the single-stream metering process and the multistream metering process. In the single-stream metering process, the polymers are metered into the main inlet of the mixing assembly together with the additives. For this, use is made of feed hoppers and/or ancillary input equipment with horizontal or vertical screws. The multistream metering process is also termed fractionated metering or the split-feed technique. Here, various constituents are added separately. A distinction is also made between volumetric metering and gravimetric metering. In the case of volumetric metering, appropriately designed screws for pellets, powder, fiber, and chips have what are known as decompactors, as required by the flow behavior of the bulk material. Besides screws, vibrating troughs or belt metering systems are also used for the volumetric metering of pellets, coarse-grained powder, fibers, or flakes.

Gravimetric metering equipment used comprises velocity-regulated and weight-regulated metering belt weighers, metering screw weighers, differential metering weighers with screw or vibrating trough, and quasi-continuous hopper weighers.

The annular groove metering system is used for volumetric or gravimetric metering of very small amounts of powder (about 10 g/h), this being where screw metering systems fail. Liquid constituents are fed to the mixing assembly through, by way of example, volumetric metering pumps. If the metering pumps are regulated by means of a differential weigher, gravimetric metering is also possible for the addition of liquids.

Another possibility is pulsed or ramped addition of additives by way of other metering units. By way of example, an ejector weigher is used for pulsed addition. In the metering process, a distinction is made between gravimetric and volumetric addition.

The mixture prepared may be exposed for a certain period or over a certain distance downstream of the mixing assembly to a defined environment or treatment or treatment pathway. In this process, the mixture may be exposed to certain temperature and humidity conditions, or to a temperature profile, or to one or more liquids, to moisture, to one or more gases, to one or more solids, or to mixtures of liquids and gases and solids, or to one or more types of electromagnetic radiation. In this context, liquids or solids may be any of the organic or inorganic liquid and/or solid substances and/or biological living matter or substances. Another possible treatment is a mechanical load.

1. A process for the continuous preparation of mixtures from at least one thermoplastic polymer and at least one additive, which comprises continuously feeding at least one thermoplastic polymer to a mixing assembly and melting the same and mixing the same with one or more additives, the concentration of at least one additive being varied continuously, and continuously discharging the polymer mixture from the mixing assembly and converting the same into a form which can be subjected to further processing and testing.

2. The process for the continuous preparation of mixtures from at least one thermoplastic polymer and at least one additive, which comprises continuously feeding at least one thermoplastic polymer to a mixing assembly and melting the same and mixing the same with one or more additives, one or more additives being fed to the mixing assembly in such a way that the residence time characteristics of the mixing assembly generate an initially rising and then falling concentration gradient of one or more additives in the discharged polymer mixture, and continuously discharging the polymer mixture from the mixing assembly and converting the same into a form which can be subjected to further processing and testing.

3. The process as claimed in one or more of claims 1 to 2, one or more additives being fed in the form of a concentration pulse and/or of a concentration pulse sequence and/or in the form of a concentration ramp.

4. The process as claimed in one or more of claims 1 to 3, using at least one screw-based machine as mixing assembly.

5. The process according to one or more of claims 1 to 4, using at least one polymer as additive.

6. The process as claimed in one or more of claims 1 to 5, using at least one thermoplastic polymer as additive.

7. The process as claimed in one or more of claims 1 to 6, discharging the mixture continuously from the mixing assembly and processing the same to give a molding.

8. The process as claimed in claim 7, the molding being a strip of film or an extrudate.

9. The process as claimed in one or more of claims 1 to 8, the design of the die of the mixing assembly generating a concentration gradient perpendicular to the conveying direction of the mixing assembly.

10. The process as claimed in one or more of the preceding claims, the mixture being discharged continuously from the mixing assembly and being processed to give a self-supporting strip of film or an extrudate, and being converted into discrete fragments.

11. The process as claimed in claim 10, the mixture being converted into discrete fragments by the chopping, stamping-out, or palletizing of a strip of film or of an extrudate.

12. A molding made from a polymer composition which has, longitudinally and/or transversely, at least one concentration gradient of one or more additives.

13. The molding as claimed in claim 12, obtainable by the process as claimed in one or more of claims 1 to 11.

14. The use of moldings as claimed in claim 12 or 13 for the high-throughput screening of polymer compositions, in particular as a substance library or as a constituent of a substance library for the high-throughput screening of polymer compositions.

15. The use of a process as claimed in one or more of claims 1 to 11 for producing substance libraries for the high-throughput screening of polymer compositions.
